(19) United States
(12) Patent Application Publication
(10) Pub. No.: US 2004/0229025 A1
(43) Pub. Date: Nov. 18, 2004

(54) Voltage tunable photodefinable dielectric and method of manufacture therefore

(76) Inventors: Chen Zhang, Clarksville, MD (US); Xiachong Tang, Columbia, MD (US); Luna Chiu, Ellicott City, MD (US)

Correspondence Address: James S. Finn, 8650 Southwestern Blvd. #2825, Dallas, TX, 75206-2688, US

(21) Appl. No.: 10/822,326

(22) Filed: Apr. 12, 2004

Related U.S. Application Data
(60) Provisional application No. 60/462,174, filed on Apr. 11, 2003.

(51) Int. Cl. B05D 3/12; B32B 7/00

(52) U.S. Cl. 428/209; 427/558; 427/430.1; 427/240

(57) ABSTRACT

This invention provides a method of fabricating a tunable dielectric slurry, comprising, depositing a thick film tunable dielectric onto a substrate, subjecting the thick film to UV radiation exposure after it is coated onto the substrate, drying and baking the thick film and the substrate, applying a developer to the thick film and the substrate, the developer capable of washing away an unexposed area of the thick film and retaining an exposed area enabling a latent pattern to be brought out and thus creating a patterned film, and sintering the substrate.

### CROSS REFERENCE TO A RELATED APPLICATION

This application claims the benefit of U.S. Provisional Application Ser. No. 60/462,174, filed Apr. 11, 2003 entitled, PARASCAN® PHOTODEFINABLE DIELECTRIC” by Tang et al.

### BACKGROUND OF INVENTION

In the field of hybrid microelectronics, integration of semiconductors and passive components and interconnects are placed onto a single substrate. Currently, there are two different technologies for processing these components and can be generalized as thick film and thin film processes.

Thick film technology typically refers to screen printing of pastes or inks. Typically, in the past Parascan® (described in detail below) tunable capacitors are made by screen printing. However, standard screen-printing dimensions of the patterned feature may be limited to 4 mils. This indicates that the size of the components made of these dielectric and/or ceramic materials may be at least 4 mils×4 mils. This fact brings many disadvantages including space occupation limits, increased materials scrap, and design limitations.

In thin film technology, the UV patterning of photoresist is used to produce an image and then some type of vacuum deposition is usually used to place the materials of interest onto the substrate. In thin film technology, the feature sizes are small from a few to tens of microns is standard. However, the cost and time of vacuum deposition is usually higher than conventional thick film technology. Also usually due to cost limitations, the thickness of vacuum material deposition is limited to less than a few microns.

In modern technologies, minimization is a driving force. Low cost, compact and highly functional components always have the highest demands. Currently, conventional ceramic thick film deposition to form small features down to 20 um size has not been available because of the difficulties in current ceramic body forming technologies.

Thus, there is a need for methods of manufacturing hybrid electronics which integrate semiconductors and passive components and interconnects onto a single substrate.

### SUMMARY OF THE INVENTION

This invention provides a method of fabricating a tunable dielectric slurry, comprising, depositing a thick film tunable dielectric onto a substrate, subjecting the thick film to UV radiation exposure after it is coated onto the substrate, drying and baking the thick film and the substrate, applying a developer to the thick film and the substrate, the developer capable of washing away an unexposed area of the thick film and retaining an exposed area enabling a latent pattern to be brought out and thus creating a patterned film, and sintering the substrate. The thick film may be screen printed onto the substrate wherein the thick film is thixotropic or the thick film may be spin coated onto the substrate and Newtonian. The step of depositing a thick film onto a substrate may be accomplished by a technique selected from a group consisting of: transfer coating; tape casting; and dip coating. Further, the step of subjecting the thick film to UV radiation exposure after it is coated onto the substrate may include using a photo mask in the exposure process to define exposure patterns intended for the film to receive. The components of one embodiment of the present invention may be selected from the group consisting of: ceramic powder; photosensitive polymer; photoinitiator; solvents; photo inhibitor; and adhesion promoter. The tunable dielectric material of the present invention may include Parascan® Tunable dielectric.

The present invention also provides a method of manufacturing a photodefinable tunable dielectric, comprising, preparing a slurry to be photopatterned, the slurry containing a tunable dielectric powder and the preparation comprising hand mixing and mill mixing the slurry to reach homogenization, photopatterning the slurry, the photopatterning comprising, stirring and mixing the slurry, spin coating the slurry to form a pre-fired film, soft baking the film, exposing and developing the film, rinsing and drying the developed film, and firing the film. The stirring of the slurry may be hand stirred and the mixing may be ultrasonic. Further, the present invention provides for measuring the viscosity of the slurry and the soft baking may be from 90° C. to 120° C. for 2-4 minutes. The exposure time for exposing the film may be sensitive to the film thickness and may vary from 2-10 seconds for film thickness from 2-10 um. The firing may have a peak temperature of 1100° C. and film shrinkage may be approximately 40%-50%. Although the scope of the present invention is not limited in this respect as numerous exposure times, temperatures, film shrinkage and thickness are anticipated by the present invention and the examples above are merely illustrative.

Another embodiment of the present invention provides for a vertical varactor, comprising: a substrate; at least two electrodes placed on the substrate to form a gap between the electrodes; and a tunable dielectric thick film in the gap between the at least two electrodes. The vertical varactor may be made from a photo patternable thick film process and wherein the process may include depositing a thick film tunable dielectric onto a substrate and subjecting the thick film to UV radiation exposure after it is coated onto the substrate; drying and baking the thick film and the substrate; applying a developer to the thick film and the substrate, the developer capable of washing away an unexposed area of the thick film and retaining an exposed area enabling a latent pattern to be brought out and thus creating a patterned film; and sintering the thick film and substrate.

The vertical varactor of the present invention also provides that the photopatternable thick film process comprises: preparing a slurry to be photopatterned, the slurry containing a tunable dielectric powder and the preparation comprising hand mixing and mill mixing the slurry to reach homogenization; and photopatterning the slurry, the photopatterning comprising: stirring and mixing the slurry; spin coating the slurry to form a pre-fired film; soft baking the film; exposing and developing the film; rinsing and drying the developed film; and firing the film.

Yet another embodiment of the present invention provides for a coplanar varactor, comprising: a substrate; a tunable dielectric thick film on the substrate; and at least two electrodes placed on the substrate so as to form a gap between the electrodes. The coplanar varactor may be made from a photo patternable thick film process and wherein the photo patternable thick film process comprises: depositing a thick film tunable dielectric onto a substrate; subjecting the thick film to UV radiation exposure after it is coated onto the substrate; drying and baking the thick film and the substrate; applying a developer to the thick film and the substrate, the developer capable of washing away an unexposed area of the thick film and retaining an exposed area enabling a latent pattern to be brought out and thus creating a patterned film; and sintering the thick film and substrate.

The coplanar varactor of the present invention further provides that the photopatternable thick film process comprises: preparing a slurry to be photopatterned, the slurry containing a tunable dielectric powder and the preparation comprising hand mixing and mill mixing the slurry to reach homogenization; and photopatterning the slurry, the photopatterning comprising: stirring and mixing the slurry; spin coating the slurry to form a pre-fired film; soft baking the film; exposing and developing the film; rinsing and drying the developed film; and firing the film.

### BRIEF DESCRIPTION OF THE DRAWINGS

The subject matter regarded as the invention is particularly pointed out and distinctly claimed in the concluding portion of the specification. The invention, however, both as to organization and method of operation, together with objects, features, and advantages thereof, may best be understood by reference to the following detailed description when read with the accompanying drawings in which:

FIG. 1 shows the general process diagram of photo-patternable thick film formulation, deposition, patterning and sintering;

FIG. 2 graphically illustrates the typical rheology for spin coating slurry;

FIG. 3 graphically illustrates the typical rheology for screen printing paste;

FIG. 4 shows the UV exposed and developed ceramic thick film green pattern on a MgO substrate;

FIG. 5 shows the sintered thick film pattern;

FIG. 6 shows schematic diagram of a thick film coplanar varactor.

FIG. 7(a) shows schematic diagram of a thick film vertical varactor;

FIG. 7(b) illustrates a top view picture of a thick film vertical varactor made using photo-patternable thick film technology;

FIG. 8 graphically depicts a comparison of electrical properties between coplanar and vertical varactors shown in FIG. 6 and FIG. 7;

FIG. 9 illustrates a schematic diagram of the structure of another type of vertical varactors;

FIG. 10 illustrates the improvement for coplanar structures built using photodefinable film; and

FIG. 11 illustrates the improvement for vertical parallel plate structures.

It will be appreciated that for simplicity and clarity of illustration, elements illustrated in the figures have not necessarily been drawn to scale. For example, the dimensions of some of the elements are exaggerated relative to other elements for clarity. Further, where considered appropriate, reference numerals have been repeated among the figures to indicate corresponding or analogous elements.

### DETAILED DESCRIPTION OF THE INVENTION

The present invention provides a new process for tunable electronics in the hybrid microelectronics area and by combining thick film coating technology with thin film micro photolithography technology, may directly form green ceramic features down to the size in micrometer range. Subsequently, the small green features can be sintered to form ceramic patterns which have widespread applications in various areas in the modem electronic and RF industry. The present invention enables the ability to achieve smaller line widths and spacings compared to current conventional thick film technology as well as the ability to increase part density on a single substrate thereby saving space, decreasing material scrap and reducing cost. It further provides the ability to build optimized structures which can reduce or eliminate stray capacitance in a simple and reworkable process that is more benign than etching

The term Parascan® as used herein is a trademarked word indicating a tunable dielectric material developed by the assignee of the present invention. Parascan® tunable dielectric materials have been described in several patents. Barium strontium titanate (BaTiO₃—SrTiO₃), also referred to as BSTO, is used for its high dielectric constant (200-6,000) and large change in dielectric constant with applied voltage (25-75 percent with a field of 2 Volts/micron). Tunable dielectric materials including barium strontium titanate are disclosed in U.S. Pat. No. 5,312,790 to Sengupta, et al. entitled “Ceramic Ferroelectric Material”; U.S. Pat. No. 5,427,988 by Sengupta, et al. entitled “Ceramic Ferroelectric Composite Material-BSTO-MgO”; U.S. Pat. No. 5,486,491 to Sengupta, et al. entitled “Ceramic Ferroelectric Composite Material-BSTO-ZrO₂”; U.S. Pat. No. 5,635,434 by Sengupta, et al. entitled “Ceramic Ferroelectric Composite Material-BSTO-Magnesium Based Compound”; U.S. Pat. No. 5,830,591 by Sengupta, et al. entitled “Multilayered Ferroelectric Composite Waveguides”; U.S. Pat. No. 5,846,893 by Sengupta, et al. entitled “Thin Film Ferroelectric Composites and Method of Making”; U.S. Pat. No. 5,766,697 by Sengupta, et al. entitled “Method of Making Thin Film Composites”; U.S. Pat. No. 5,693,429 by Sengupta, et al. entitled “Electronically Graded Multilayer Ferroelectric Composites”; U.S. Pat. No. 5,635,433 by Sengupta entitled “Ceramic Ferroelectric Composite Material BSTO-ZnO”; U.S. Pat. No. 6,074,971 by Chiu et al. entitled “Ceramic Ferroelectric Composite Materials with Enhanced Electronic Properties BSTO-Mg Based Compound-Rare Earth Oxide”. These patents are incorporated herein by reference. The materials shown in these patents, especially BSTO-MgO composites, show low dielectric loss and high tunability. Tunability is defined as the fractional change in the dielectric constant with applied voltage.

Barium strontium titanate of the formula BaₓSr₁₋ₓTiO₃ is a preferred electronically tunable dielectric material due to its favorable tuning characteristics, low Curie temperatures and low microwave loss properties. In the formula BaₓSr₁₋ₓTiO₃, x can be any value from 0 to 1, preferably from about 0.15 to about 0.6. More preferably, x is from 0.3 to 0.6.

Other electronically tunable dielectric materials may be used partially or entirely in place of barium strontium titanate. An example is BaₓCa₁₋ₓTiO₃, where x is in a range from about 0.2 to about 0.8, preferably from about 0.4 to about 0.6. Additional electronically tunable ferroelectrics include PbₓZr₁₋ₓTiO₃ (PZT) where x ranges from about 0.0 to about 1.0, PbₓZr₁₋ₓSrTiO₃ where x ranges from about 0.05 to about 0.4, KTaₓNb₁₋ₓO₃ where x ranges from about 0.0 to about 1.0, lead lanthanum zirconium titanate (PLZT), PbTiO₃, BaCaZrTiO₃, NaNO₃, KNbO₃, LiNbO₃, LiTaO₃, PbNb₂O₆, PbTa₂O₆, KSr(NbO₃) and NaBa₂(NbO₃)₅KH₂PO₄, and mixtures and compositions thereof. Also, these materials can be combined with low loss dielectric materials, such as magnesium oxide (MgO), aluminum oxide (Al₂O₃), and zirconium oxide (ZrO₂), and/or with additional doping elements, such as manganese (MN), iron (Fe), and tungsten (W), or with other alkali earth metal oxides (i.e. calcium oxide, etc.), transition metal oxides, silicates, niobates, tantalates, aluminates, zirconnates, and titanates to further reduce the dielectric loss.

In addition, the following U.S. Pat. Applications, assigned to the assignee of this application, disclose additional examples of tunable dielectric materials: U.S. application Ser. No. 09/594,837 filed Jun. 15, 2000, entitled “Electronically Tunable Ceramic Materials Including Tunable Dielectric and Metal Silicate Phases”; U.S. application Ser. No. 09/768,690 filed Jan. 24, 2001, entitled “Electronically Tunable, Low-Loss Ceramic Materials Including a Tunable Dielectric Phase and Multiple Metal Oxide Phases”; U.S. application Ser. No. 09/882,605 filed Jun. 15, 2001, entitled “Electronically Tunable Dielectric Composite Thick Films And Methods Of Making Same”; U.S. application Ser. No. 09/834,327 filed Apr. 13, 2001, entitled “Strain-Relieved Tunable Dielectric Thin Films”; and U.S. Provisional Application Ser. No. 60/295,046 filed Jun. 1, 2001 entitled “Tunable Dielectric Compositions Including Low Loss Glass Frits”. These patent applications are incorporated herein by reference.

The tunable dielectric materials can also be combined with one or more non-tunable dielectric materials. The non-tunable phase(s) may include MgO, MgAl₂O₄, MgTiO₃, Mg₂SiO₄, CaSiO₃, MgSrZrTiO₆, CaTiO₃, Al₂O₃, SiO₂ and/or other metal silicates such as BaSiO₃ and SrSiO₃. The non-tunable dielectric phases may be any combination of the above, e.g., MgO combined with MgTiO₃, MgO combined with MgSrZrTiO₆, MgO combined with Mg₂SiO₄, MgO combined with Mg₂SiO₄, Mg₂SiO₄ combined with CaTiO₃ and the like.

Additional minor additives in amounts of from about 0.1 to about 5 weight percent can be added to the composites to additionally improve the electronic properties of the films. These minor additives include oxides such as zirconnates, tannates, rare earths, niobates and tantalates. For example, the minor additives may include CaZrO₃, BaZrO₃, SrZrO₃, BaSnO₃, CaSnO₃, MgSnO₃, Bi₂O₃/2SnO₂, Nd₂O₃, Pr₇O₁₁, Yb₂O₃, Ho₂O₃, La₂O₃, MgNb₂O₆, SrNb₂O₆, BaNb₂O₆, MgTa₂O₆, BaTa₂O₆ and Ta₂O₃.

Thick films of tunable dielectric composites can comprise Ba₁₋ₓSrₓTiO₃, where x is from 0.3 to 0.7 in combination with at least one non-tunable dielectric phase selected from MgO, MgTiO₃, MgZrO₃, MgSrZrTiO₆, Mg₂SiO₄, CaSiO₃, MgAl₂O₄, CaTiO₃, Al₂O₃, SiO₂, BaSiO₃ and SrSiO₃. These compositions can be BSTO and one of these components, or two or more of these components in quantities from 0.25 weight percent to 80 weight percent with BSTO weight ratios of 99.75 weight percent to 20 weight percent.

The electronically tunable materials can also include at least one metal silicate phase. The metal silicates may include metals from Group 2A of the Periodic Table, i.e., Be, Mg, Ca, Sr, Ba and Ra, preferably Mg, Ca, Sr and Ba. Preferred metal silicates include Mg₂SiO₄, CaSiO₃, BaSiO₃ and SrSiO₃. In addition to Group 2A metals, the present metal silicates may include metals from Group 1A, i.e., Li, Na, K, Rb, Cs and Fr, preferably Li, Na and K. For example, such metal silicates may include sodium silicates such as Na₂SiO₃ and NaSiO₃-5H₂O, and lithium-containing silicates such as LiAlSiO₄, Li₂SiO₃ and Li₄SiO₄. Metals from Groups 3A, 4A and some transition metals of the Periodic Table may also be suitable constituents of the metal silicate phase. Additional metal silicates may include Al₂Si₂O₇, ZrSiO₄, KalSi₃O₈, NaAlSi₃O₈, CaAl₂Si₂O₈, CaMgSi₂O₆, BaTiSi₃O₉ and Zn₂SiO₄. The above tunable materials can be tuned at room temperature by controlling an electric field that is applied across the materials.

In addition to the electronically tunable dielectric phase, the electronically tunable materials can include at least two additional metal oxide phases. The additional metal oxides may include metals from Group 2A of the Periodic Table, i.e., Mg, Ca, Sr, Ba, Be and Ra, preferably Mg, Ca, Sr and Ba. The additional metal oxides may also include metals from Group 1A, i.e., Li, Na, K, Rb, Cs and Fr, preferably Li, Na and K. Metals from other Groups of the Periodic Table may also be suitable constituents of the metal oxide phases. For example, refractory metals such as Ti, V, Cr, Mn, Zr, Nb, Mo, Hf, Ta and W may be used. Furthermore, metals such as Al, Si, Sn, Pb and Bi may be used. In addition, the metal oxide phases may comprise rare earth metals such as Sc, Y, La, Ce, Pr, Nd and the like.

The additional metal oxides may include, for example, zirconnates, silicates, titanates, aluminates, stannates, niobates, tantalates and rare earth oxides. Preferred additional metal oxides include Mg₂SiO₄, MgO, CaTiO₃, MgZrSrTiO₆, MgTiO₃, MgAl₂O₄, WO₃, SnTiO₄, ZrTiO₄, CaSiO₃, CaSnO₃, CaWO₄, CaZrO₃, MgTa₂O₆, MgZrO₃, MnO₂, PbO, Bi₂O₃ and La₂O₃. Particularly preferred additional metal oxides include Mg₂SiO₄, MgO, CaTiO₃, MgZrSrTiO₆, MgTiO₃, MgAl₂O₄, MgTa₂O₆ and MgZrO₃.

The additional metal oxide phases are typically present in total amounts of from about 1 to about 80 weight percent of the material, preferably from about 3 to about 65 weight percent, and more preferably from about 5 to about 60 weight percent. In one preferred embodiment, the additional metal oxides comprise from about 10 to about 50 total weight percent of the material. The individual amount of each additional metal oxide may be adjusted to provide the desired properties. Where two additional metal oxides are used, their weight ratios may vary, for example, from about 1:100 to about 100:1, typically from about 1:10 to about 10:1 or from about 1:5 to about 5:1. Although metal oxides in total amounts of from 1 to 80 weight percent are typically used, smaller additive amounts of from 0.01 to 1 weight percent may be used for some applications.

The additional metal oxide phases can include at least two Mg-containing compounds. In addition to the multiple Mg-containing compounds, the material may optionally include Mg-free compounds, for example, oxides of metals selected from Si, Ca, Zr, Ti, Al and/or rare earths.

The present invention provides two distinct methodologies that have been developed by the assignee of the present invention for the photodefinable process utilizing Parascan®. One is a film that is screen printable or spin coatable using photoinitiators, solvents and additives. The second process is a spin coatable film using unique tunable materials and commercial resists. The current resolution of both methodologies may be resolved to 10 microns.

In order to pattern Parascan® dielectric materials, the photodefinable slurry may contain two basic components: Parascan® tunable dielectric materials and a photodefinable vehicle. By selecting different photodefinable vehicles, Parascan® photodefinable slurry can be made either positive tone or negative tone. Once the photodefinable vehicle is selected, different Parascan® dielectric materials may be mixed in to achieve the various properties required, including tuning, Q, capacitance, etc. In both methods, the composition of the ceramic slurry used for green pattern deposition may be a factor in the success of the photodefinable coating.

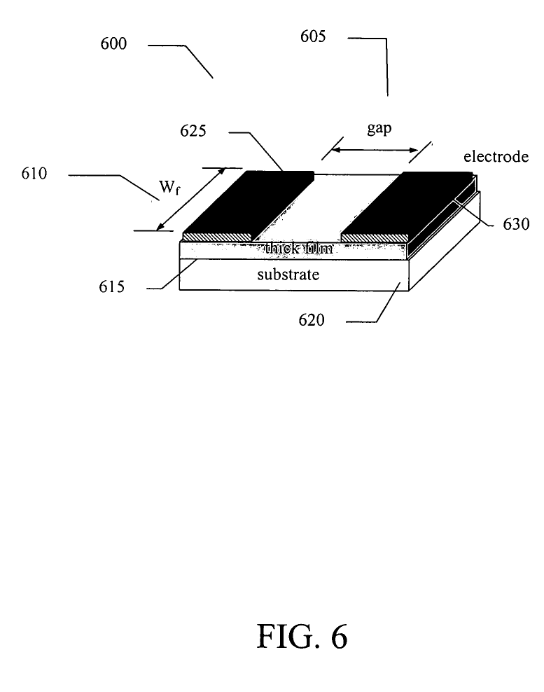

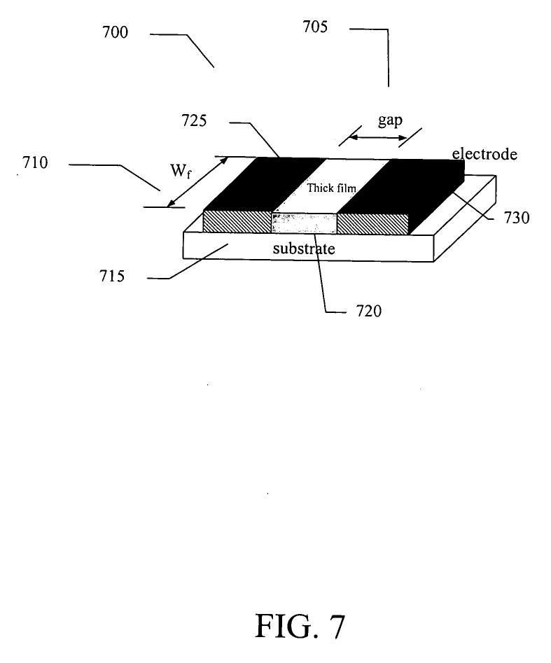

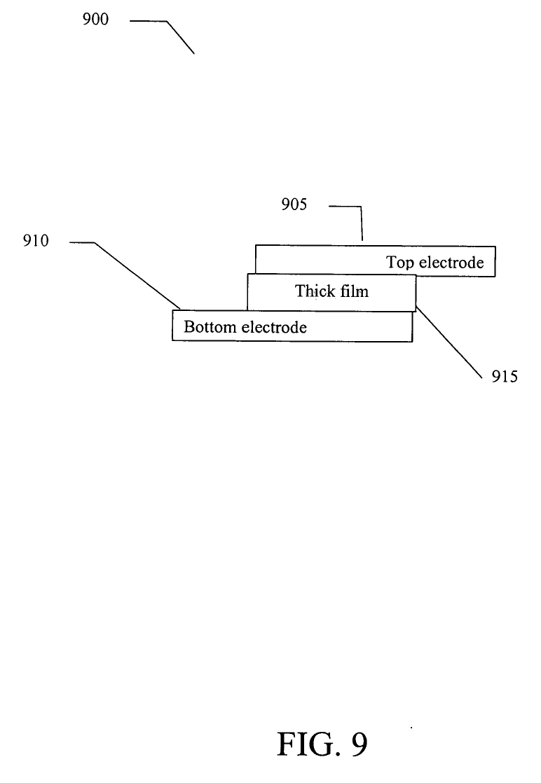

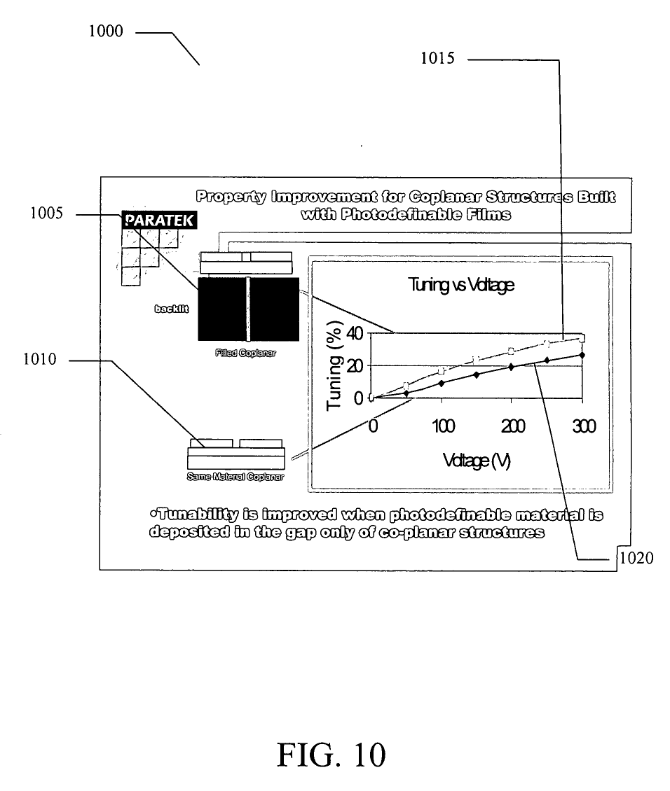

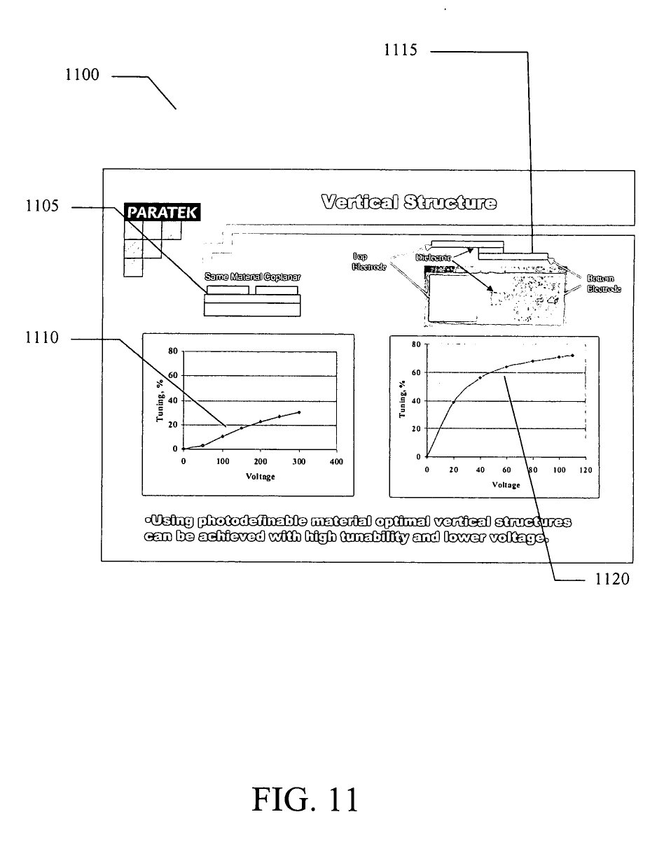

In addition to that advantages of smaller feature sizes; decreased scrap is the ability to produce unique designs by more carefully limiting where tunable capacitive material is placed. For example tunable capacitors or phase shifters made by screen printing technology have used coplanar structures in the past (described in more detail below with reference to FIG. 6). This structure requires higher voltage in order to achieve the tunability desired. It makes many applications more difficult because most of the commercial applications in the telecommunication business prefer voltages of 50V or lower. Higher voltages (200-300V) not only increases cost, but also increases the size of the final devices. However, using the photodefined material, at least two structures may be made to decrease voltage: one is a filled coplanar gap (described in detail below with reference to the structure illustrated in FIG. 7 and the other is a parallel plate structure (described in detail below with reference to the structure depicted in FIG. 9). In both of these structures, photodefined Parascan® material is used and the required voltages are decreased for similar tunability. Also, the basic Q (quality factor) of the structure can be increased by selective placement and patterning of the material such that RF fields travel through the least amount of dielectric and stray capacitance is decreased which also increases the Q of the device. These advantages are described with reference to FIGS. 10 and 11.

A first method according to the present invention provides that in the composition, the components may include, but not limited to, the following groups:

1. Ceramic powder. This is an excellent functional material after sintering and may be the only constitute left after firing.

2. Photosensitive polymer. This is a functional material during UV curing and may be the basis for patterning.

3. Photoinitiator. This may the starting materials for cross linking of the photosensitive polymer.

4. Solvents. They may provide a desired environment for mixing of ceramic powder and photosensitive polymer and other components. They may also contribute to the rheology of the slurry.

5. Photo inhibitor. It may absorb UV light and may control the sensitivity of the slurry.

6. Adhesion promoter. It may promote the adhesion between the coating and the substrate.

Although the scope of the present invention is not limited in this respect

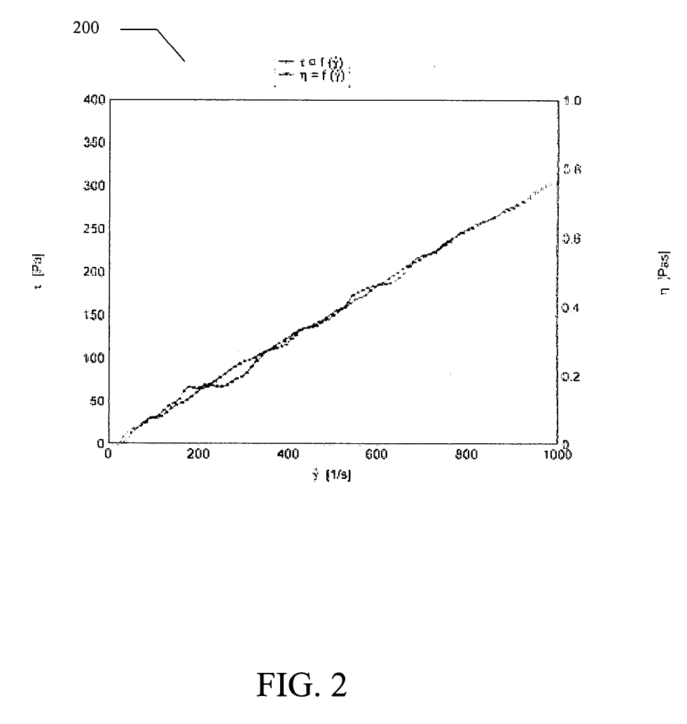

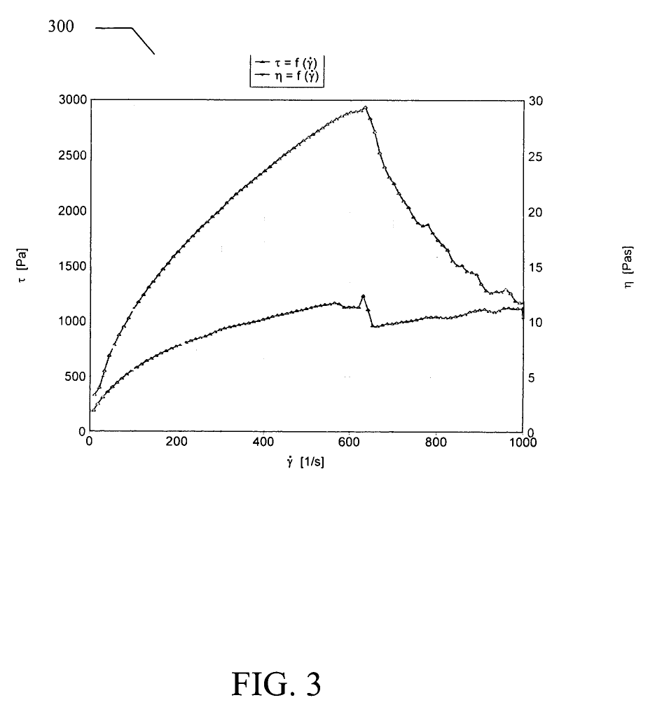

As graphically shown in FIG. 2 at 200 and FIG. 3 at 300, depending on how the thick film is deposited onto a substrate, the slurry has different rheology characteristics. For example, if the thick film is screen printed, the slurry should be thixotropic. If the thick film is spin coated onto the substrate, the slurry should be Newtonian. However, the deposition method is not limited to the two mentioned above. Transfer coating, tape casting, dip coating and other methods can all be used for thick film deposition if appropriate rheology can be identified and obtained in the formulation of the slurry, ink or paste. Although the scope of the present invention is not limited in this respect

The thick film is subjected to UV radiation exposure after it is coated onto a substrate (or other backing support in case of tape casting, etc.) and dried. A photo mask is used in this exposure process to define exposure patterns intended for the film to receive. The exposure dose is determined by exposure time. An optimal exposure may be utilized in order to resolve the desired pattern throughout the thickness of the film.

After exposure, a baking process is followed for the purpose of promoting cross linking of the photo sensitive polymer in the UV exposed area of the film. The next step is to use a developer to wash away the unexposed area of the film and retain the exposed area so that the latent pattern may be brought out. Thus, the patterning process may be finished to obtain a ceramic green pattern.

The patterned film then may undergo a sintering process to burn out the polymer and other organic components and the ceramic may thus be densified to obtain a fired ceramic pattern.

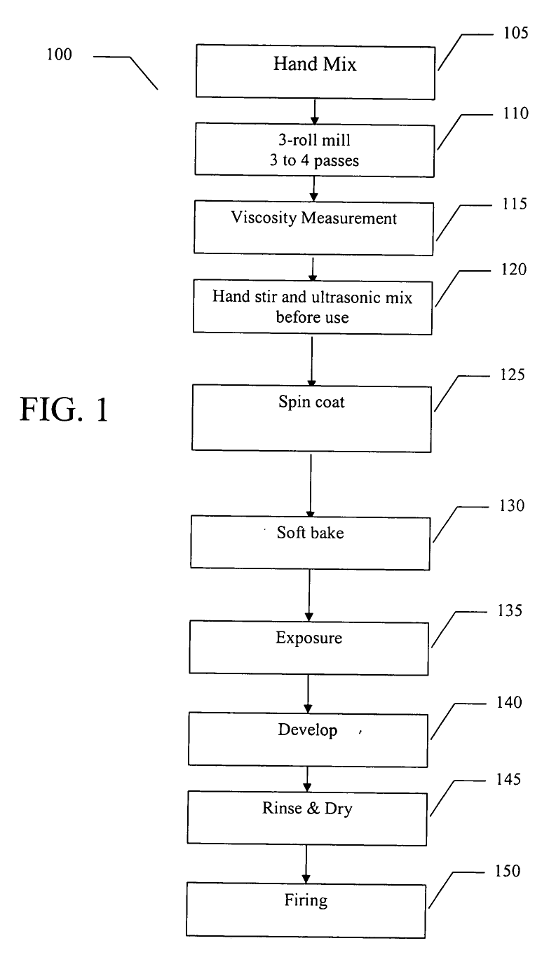

FIG. 1 at 100 illustrates a method of the present invention wherein the photodefinable vehicle can be either made from scratch or using commercial available vehicle. An embodiment of the current invention uses commercially available positive photosensitive polymer system.

The method may begin at 105 wherein hand mixing occurs. Hand mixing as set forth herein it is meant to mean any method that accomplishes a mixing that would be similar to a motion such as hand mixing. It is understood that the present invention is not limited to manual mixing with one's hands. Further, it is understood that any number of ways to mix are intended to be within the scope of the present invention and hand mixing is but one of countless ways to mix.

Next, at 110, the slurry may be mill mixed, with for example a 3-roll mill and the number of passes may be 3 to 4, although the scope of the present invention is not limited in this respect as it is understood that a wide variety of roll mills and passes are intended to be within the scope of the present invention. The viscosity of the slurry may be measured at 115 and then hand stirred and mixed ultrasonically before use at 120. Hand stirring as set forth herein it is meant to mean any method that accomplishes a stirring that would be similar to a motion similar to that with hand stirring. It is understood that the present invention is not limited to manual stirring with one's hands. Further, it is understood that any number of ways to stir are intended to be within the scope of the present invention and hand stirring is but one of countless ways to stir. The next step in the present method is spin coating at 125 and soft baking at 130. This is followed by exposure at 135, developing at 140, rinse and drying at 145 and firing at 150.

Parameters such as spin coat speed, soft bake temperature and time, exposure time and develop time may be related to the type of photosensitive polymer system selected. However, the final process parameters may be determined by experimental studies.

In one embodiment, the photodefinable slurry may use BPRS300 obtainable from Arch Chemicals, Inc. Solid loading for the slurry may be typically 40 wt %. Thus, this embodiment may be 40 wt % of Parascan® dielectric powder and 60 wt % of BPRS300. The two systems may then be hand mixed together followed by 3-roll mill mixing to reach homogenization. The mixed slurry is tested on the HARKA to obtain information including viscosity and shearing characteristic before storage. It is understood tat the slurry percentage are for illustrative purposes and for providing detail to one embodiment of the present invention and should not be read to limit the slurry components and percentages in any way.

Due to density difference, the Parascan® dielectric powder may tend to separate from the photosensitive polymer system after storage. Therefore, it is important to perform an ultrasonic mixing before use by putting the slurry container in an ultrasonic bath for 10 min. Hand stir before and after ultrasonic mixing is recommended depending on the storage time, but is not required.

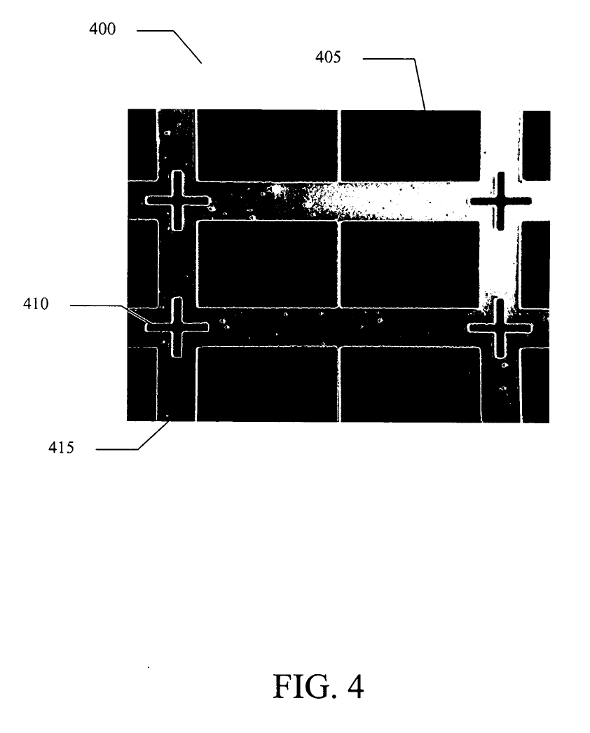

At this point, the slurry may be ready to be patterned. FIG. 4, shown generally as 400, illustrates patterns 410 in green ceramic thick film 415 on MgO substrate 405. The thickness of pre-fired film may be determined by the spin coat speed and time, which is associated to the viscosity of the slurry. Soft baking from 90° C. to 120° C. for 2-4 minutes is recommended depending on the thickness of the film. This soft bake time is but one example of temperature and times and is not meant to limit the soft baking in anyway. Exposure time may also be sensitive to the film thickness. It may vary from 2-10 seconds for film thickness from 2-10 um. The developer used may be PLSI recommended by Arch Chemicals, Inc. To achieve the best resolution, concentration of 70% PLSI may be used even though concentration lower than 70% may also work. Develop time for 70% PLSI is typically around 60 seconds. The develop time may vary with feature size.

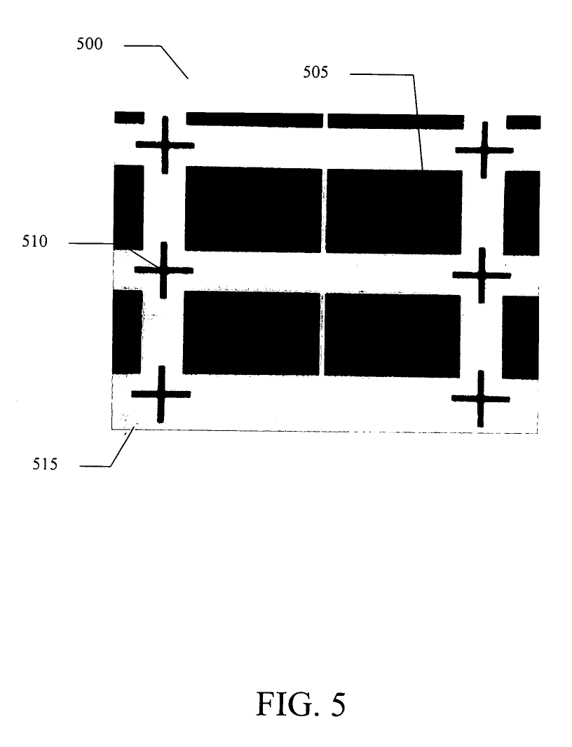

The firing profile may be determined by Parascan® dielectric system. FIG. 5, shown generally at 500, illustrates the sintered patterned 510 ceramic thick film 515 on MgO substrate 505. Peak temperature of 1100° C. may be used and film shrinkage may typically be around 40%-50%. One of the smaller line or spaces resolved using the aforementioned slurry may be 15 um. Although sizes smaller than 15 um is also anticipated by the present invention.

Turning now to FIG. 6, shown generally as 600, is a schematic diagram of a co-planar varactor wherein on a substrate 620 is placed a thick film 615. Electrodes 625 and 630 are placed on said thick film 615 so as to form a gap 605. Width is illustrated at 610.

FIG. 7, at 700, is a schematic of a vertical varactor wherein on a substrate 715 may be placed electrodes 725 and 730. Between said electrodes 725 and 730 may be placed thick film 705. Width is illustrated at 710 to illustrate the size capabilities of the present invention.

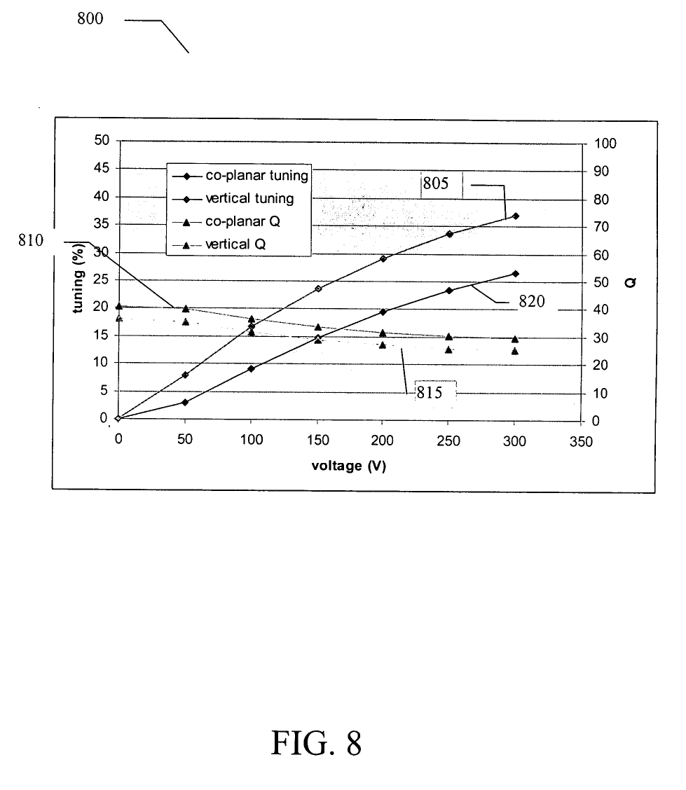

Turning now to FIG. 8 at 800 is a comparison of electrical properties of the co-planar and vertical varactors described in FIG. 6 and FIG. 7 in tuning percentage vs. voltage. 805 illustrates vertical tuning, 810 co-planar Q, 820 co-planar tuning, and 815 vertical Q.

FIG. 9 schematically illustrates at 900, another type of vertical varactor. Herein on bottom electrode 910 is placed thick film 915 in an offset manner. Further, top electrode 905 is placed on and extending past the edge of thick film 915.

To illustrate the benefits of the present invention, FIG. 10, at 1000, graphically illustrates the property improvements for Co-planar structures built with photodefinable films. The graph of tuning percentage vs. voltage illustrates that filled co-planar structure 1005 has improved tuning at a given voltage as at 1015. The same material co-planar 1010 without being filled tunability at a given voltage is shown at 1020. Thus, it can be seen that tunablilty is improved when photodefinable material is deposited in the gap only of co-planar structures as made possible by the present invention.

At 1100 in FIG. 11 is shown graphically at 1110 and 1120 the tuning percentage of a vertical structure using photodefinable material 1115 (graph at 1120) and same material co-planar 1105 without using the photodefinable material (graph at 1110).

While the present invention has been described in terms of its preferred embodiments, those skilled in the art will recognize that various other filters can be constructed in accordance with the invention as defined by the claims.

1. A method of fabricating a tunable dielectric slurry, comprising:
depositing a thick film tunable dielectric onto a substrate;
subjecting said thick film to Ultra Violet (UV) radiation exposure after it is coated onto said substrate;
drying and baking said thick film and said substrate;
applying a developer to said thick film and said substrate, said developer capable of washing away an unexposed area of said thick film and retaining an exposed area enabling a latent pattern to be brought out and thus creating a patterned film; and
sintering said substrate.

2. The method of claim 1, wherein said thick film is screen printed onto said substrate.

3. The method of claim 2, wherein said thick film is thixotropic.

4. The method of claim 1, wherein said thick film is spin coated onto said subsrate.

5. The method of claim 4, wherein said thick film is Newtonian.

6. The method of claim 1, wherein said step of depositing a thick film onto a substrate is accomplished by a technique selected from a group consisting of:
transfer coating;
tape casting; and
dip coating.

7. The method of claim 1, wherein said step of subjecting said thick film to UV radiation exposure after it is coated onto said substrate includes using a photo mask in the exposure process to define exposure patterns intended for the film to receive.

8. The method of claiml 1, wherein components in said fabricating a tunable dielectric slurry, are selected from the group consisting of:
ceramic powder;
photosensitive polymer;
photoinitiator;
solvents;
photo inhibitor; and
adhesion promoter.

9. The method of claim 1, wherein said tunable dielectric is Parascan® Tunable dielectric.

10. A method of manufacturing a photodefinable tunable dielectric, comprising:
preparing a slurry to be photopatterned, said slurry containing a tunable dielectric powder and said preparation comprising hand mixing and mill mixing said slurry to reach homogenization;
photopatterning said slurry, said photopatterning comprising:
stirring and mixing said slurry;
spin coating said slurry to form a pre-fired film;
soft baking said film;
exposing and developing said film;
rinsing and drying said developed film; and
firing said film.

11. The method of claim 10, wherein said stirring said slurry is hand stirred and said mixing is ultrasonic.

12. The method of claim 10, further comprising measuring the viscosity of said slurry.

13. The method of claim 10, wherein said soft baking is from 90° C. to 120° C. for 2-4 minutes.

14. The method of claim 10, wherein exposure time for exposing said film is sensitive to said film thickness and varies from 2-10 seconds for film thickness from 2-10 um.

15. The method of claim 10, wherein said firing is at a peak temperature of 1100° C. and film shrinkage is 40%-50%.

16. The method of claim 10, wherein said slurry is 40 wt % of Parascan® dielectric powder and 60 wt % of BPRS300.

17. The method of claim 10, further comprising providing a photodefinable vehicle positive photosensitive polymer system.

18. A vertical varactor, comprising:
a substrate;
at least two electrodes placed on said substrate to form a gap between said electrodes; and
a tunable dielectric thick film in said gap between said at least two electrodes.

19. The vertical varactor of claim 18, wherein said vertical varactor is made from a photo patternable thick film process.

20. The vertical varactor of claim 19, wherein said photo patternable thick film process comprises:
depositing a thick film tunable dielectric onto a substrate;
subjecting said thick film to UV radiation exposure after it is coated onto said substrate;
drying and baking said thick film and said substrate;
applying a developer to said thick film and said substrate, said developer capable of washing away an unexposed area of said thick film and retaining an exposed area enabling a latent pattern to be brought out and thus creating a patterned film; and
sintering said thick film and substrate.

21. The vertical varactor of claim 19, wherein said photopatternable thick film process comprises:
preparing a slurry to be photopatterned, said slurry containing a tunable dielectric powder and said preparation comprising hand mixing and mill mixing said slurry to reach homogenization; and
photopatterning said slurry, said photopatterning comprising:
stirring and mixing said slurry;
spin coating said slurry to form a pre-fired film;
soft baking said film;
exposing and developing said film;
rinsing and drying said developed film; and
firing said film.

22. A coplanar varactor, comprising:
a substrate;
a tunable dielectric thick film on said substrate; and
at least two electrodes placed on said substrate so as to form a gap between said electrodes.

23. The coplanar varactor of claim 22, wherein said coplanar varactor is made from a photo patternable thick film process.

24. The coplanar varactor of claim 23, wherein said photo patternable thick film process comprises:
depositing a thick film tunable dielectric onto a substrate;
subjecting said thick film to UV radiation exposure after it is coated onto said substrate;
drying and baking said thick film and said substrate;
applying a developer to said thick film and said substrate, said developer capable of washing away an unexposed area of said thick film and retaining an exposed area enabling a latent pattern to be brought out and thus creating a patterned film; and
sintering said thick film and substrate.

25. The coplanar varactor of claim 23, wherein said photopatternable thick film process comprises:
preparing a slurry to be photopatterned, said slurry containing a tunable dielectric powder and said preparation comprising hand mixing and mill mixing said slurry to reach homogenization; and
photopatterning said slurry, said photopatterning comprising:
stirring and mixing said slurry;
spin coating said slurry to form a pre-fired film;
soft baking said film;
exposing and developing said film;
rinsing and drying said developed film; and
firing said film.
